(19) United States
(12) Patent Application Publication
(10) Pub. No.: US 2017/0252656 A1
(43) Pub. Date: Sep. 7, 2017

(54) STATISTICAL MODIFIERS FOR DE-RANDOMIZATION IN AN AUGMENTED REALITY GAMING ENVIRONMENT

(71) Applicant: Victor Jr David Uy, Burnaby (CA)

(72) Inventor: Victor Jr David Uy, Burnaby (CA)

(21) Appl. No.: 15/449,809

(22) Filed: Mar. 3, 2017

Related U.S. Application Data
(60) Provisional application No. 62/303,372, filed on Mar. 3, 2016.

(51) Int. Cl. A63F 13/828; A63F 13/31; A63F 13/67; A63F 13/44

(52) U.S. Cl. CPC A63F 13/828; A63F 13/44; A63F 13/31; A63F 13/67; A63F 2300/403; A63F 2300/8052

(57) ABSTRACT

Systems and methods for calculating scores for de-randomization of contests in an augmented reality gaming environment whereby statistical modifiers are applied to virtual scores for events whereby events comprise one or more players involved in the plurality of events, determining one or more scores for the selected one or more players and modifying the score with statistical modifiers.

### CROSS-REFERENCE TO RELATED APPLICATIONS

This application claims the benefit of, and priority to U.S. provisional application 62/303,372 titled, “STATISTICAL MODIFIERS FOR FANTASY GAMING” filed on Mar. 3, 2016, the entire specification of which is incorporated herein by reference.

### BACKGROUND OF THE INVENTION

Field of the Art

The disclosure relates to the field of augmented reality gaming, and more particularly to the field of online gaming competitions with statistical modifiers for use in a large-scale fantasy gaming.

Discussion of the State of the Art

Fantasy gaming is a competition among gaming participants via a plurality of computing device who select a plurality of profiles that may mirror real-life players or entities to create a custom team. Common fantasy games include profiles corresponding to players of, for example, football, baseball, hockey and basketball, among others. Indeed, any organized competitive endeavor may be modeled in a fantasy game.

Each fantasy team participant selects profiles of players from a “real-life” league (for example, the National Hockey League), to create a team that will compete with other fantasy teams throughout a defined period of time. Profile selection is usually performed and may happen in a number of ways where valuations on each profile may exist for purposes of the competition. Fantasy participants can perform various actions with their teams that may mimic the actions available to real-life team owners. For example, players may be traded during the season between fantasy owners, players who were not previously selected may be obtained as “free agents,” and underperforming players may be “waived”.

Once the time period starts, fantasy team point accumulation may begin. Each of the profiles selected may accumulate or reduce points from their team based on real-world performance. For example, in a hockey fantasy league, where a player in the real-world makes a goal, six (6) points may be given to the fantasy team that has enrolled that particular player. However, if the same player were to have a game misconduct, minus two (−8) points may be given to the fantasy team that has enrolled that particular profile. In this way, each of the real-world players contributes to the fantasy team during the time period.

A complication of fantasy games is that each participant has different level of expertise which often results in lower skilled participants never winning a competition. This creates for uneven play and lower-skilled participants often don't take part. Further, with systems known in the art, relying solely on real-world events for fantasy sports, participants have no control over any outcomes of the competitions.

What is needed is a method to include anyone, regardless of skill, into fantasy gaming as well as to provide participants with a degree of control so that playing on fantasy platforms provides more enjoyment.

### SUMMARY OF THE INVENTION

Accordingly, the inventor has conceived and reduced to practice, in a preferred embodiment of the invention, a system and method to apply statistical modifiers to fantasy gaming.

According to a preferred embodiment of the invention, a statistical modifier gaming server may receive a plurality of selections form a plurality of user devices for example, in a fantasy gaming embodiment, basic information such a user device details, favorite teams (for example, as made available from online service providing information and statistics from live events), favorite prizes, associations to one or more other user devices (such as devices belonging to friends), selections for the user device in terms of follow or unfollow (subscribe/unsubscribe) of other user devices, or third party “feed” (via other online services) that may capable to handle notifications, a request to search, in a fantasy gaming embodiment, athletes and teams (player/team search component), whereby the user device may subscribe/unsubscribe to notifications about one or more athlete or one or more teams, or both.

In a preferred embodiment, an administration user via a user device may configure retrieval of initial sport data from statistics service providers (for example, STATS™) via a statistics service. The raw data may be analyzed, converted and then stored in application and contest databases. Associated statistics data may then be stored in a statistics database by a statistics server. At predetermined intervals, logic module, via a data subscription, may, for example, receive the most recent game schedule data from the statistics database. At predetermined intervals, a logic module may check the status of the events based on schedules received from online statistics server. If configured events correspond to a live event, statistics server may get data from online statistics service and convert data into a particular format, and save the statistical data to the statistics database. In some embodiments, at predetermined intervals, a state of all contests may be checked by the logic module. If within a pre-configured threshold before a contest start time, if the contest is not full, logic module may match participant user devices with other open contests, or, in some embodiments, mark contests that do not have matches as invalid. If a contest is full and the event is live, an application server may get the most recent statistics from the internal statistic database. Application server may then calculate a fantasy score and apply one or more statistical modifier (if applicable), and display up-to-date fantasy score to one or more to user devices. If a last event of a contest has completed, then contest post processing may begin by the contest manager. In some embodiments, at least a portion of a fantasy score may be received by an external online service. Once the contest is complete scores are calculated, rules are applied and applicable statistical modifiers are applied and a final score for each user device is calculated. the user device with the highest score is the winner. In some embodiments, user devices may apply statistical modifiers up to a specific preconfigured time, in other embodiments, statistical modifiers may applied throughout the contest.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5a is an exemplary architecture of a de-randomization system in an augmented reality gaming environment using statistical modifiers, according to a preferred embodiment of the invention.

FIG. 5b is an exemplary architecture of a detailed contest manager in a de-randomization system in an augmented reality gaming environment using statistical modifiers, according to a preferred embodiment of the invention

FIG. 6 is an exemplary embodiment of a statistical modifier deviation algorithm, according to a preferred embodiment of the invention.

FIG. 7 is an exemplary embodiment of a statistical modifier skill distribution, according to a preferred embodiment of the invention.

FIG. 8 is an exemplary process flow for configuring a contest, according to a preferred embodiment of the invention.

FIG. 9 is an exemplary high-level process flow for executing a contest, according to a preferred embodiment of the invention.

FIG. 10 is an exemplary process flow for selecting contest member identifiers in a contest, according to a preferred embodiment of the invention.

FIG. 11 is an exemplary process flow for calculating a modifier factor for a user device for de-randomization in an augmented reality gaming environment, according to a preferred embodiment of the invention.

FIG. 12 is an exemplary process flow for applying a statistical modifier factor for a user device for de-randomization in an augmented reality gaming environment, according to a preferred embodiment of the invention.

### DETAILED DESCRIPTION

The inventor has conceived, and reduced to practice, a system and method for online gaming competitions with modifiers for use in a large-scale fantasy gaming, and other features designed to increase the adoption, attractiveness and excitement of the contest to the players.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

An “event”, as used herein, is an event that may take place in “real-life”, for example, a sporting event, a stock trade, an investing session, and the like.

A “contest”, as used herein, is a competition, tournament, or challenge between a plurality of participant devices.

A “participant” as used herein, is a user device of the system that takes part in a contest. In some embodiments, a participant can be a user device, an automated process, or a human user using a computing interface to interact with the system.

A “statistical modifier” as used herein is a statistical modifier that modifies a result from a statistics server (for example a player roster result from a real sporting event) to modify the outcome of the statistic.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

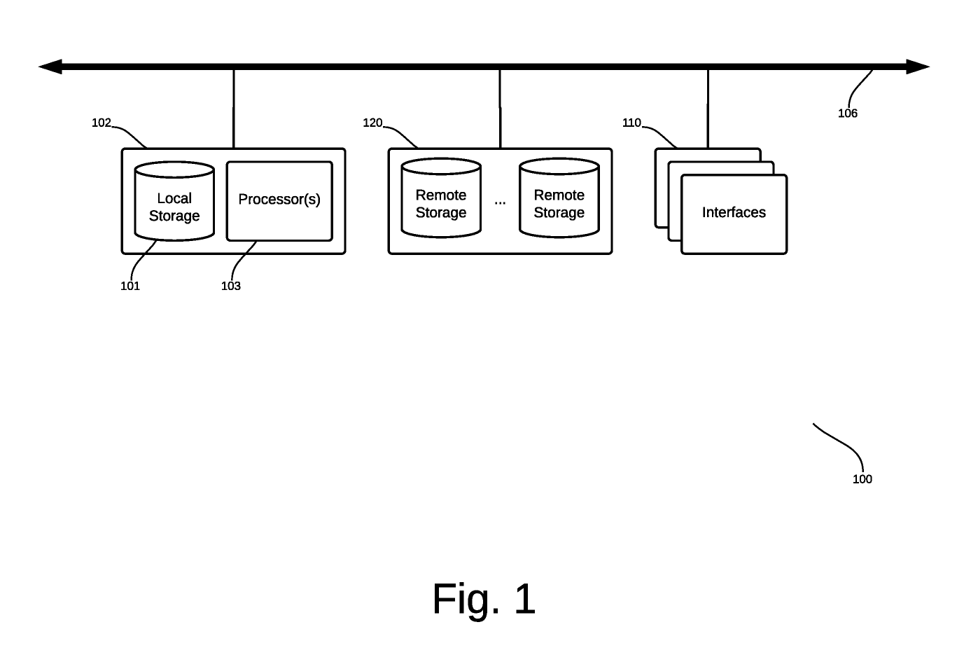

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

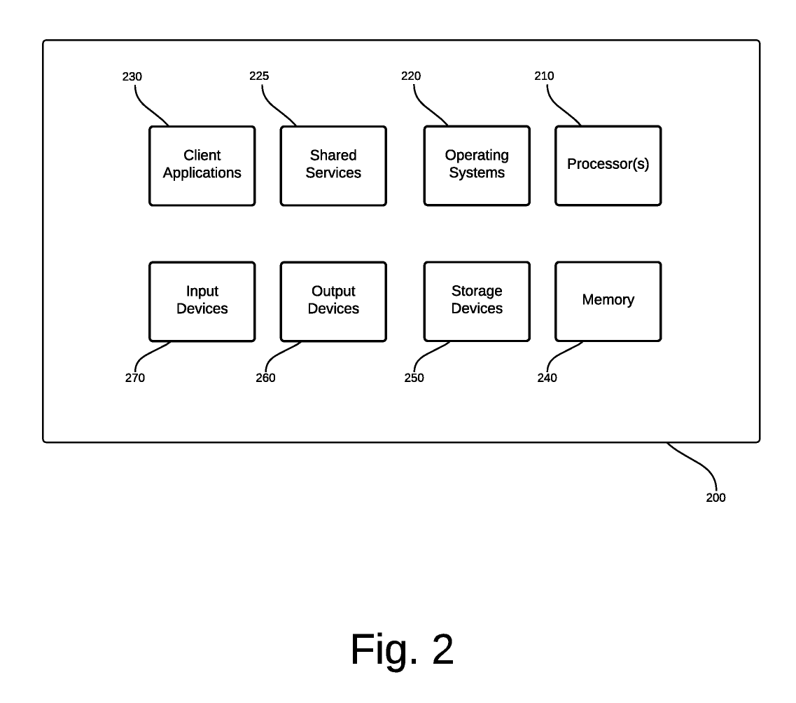

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

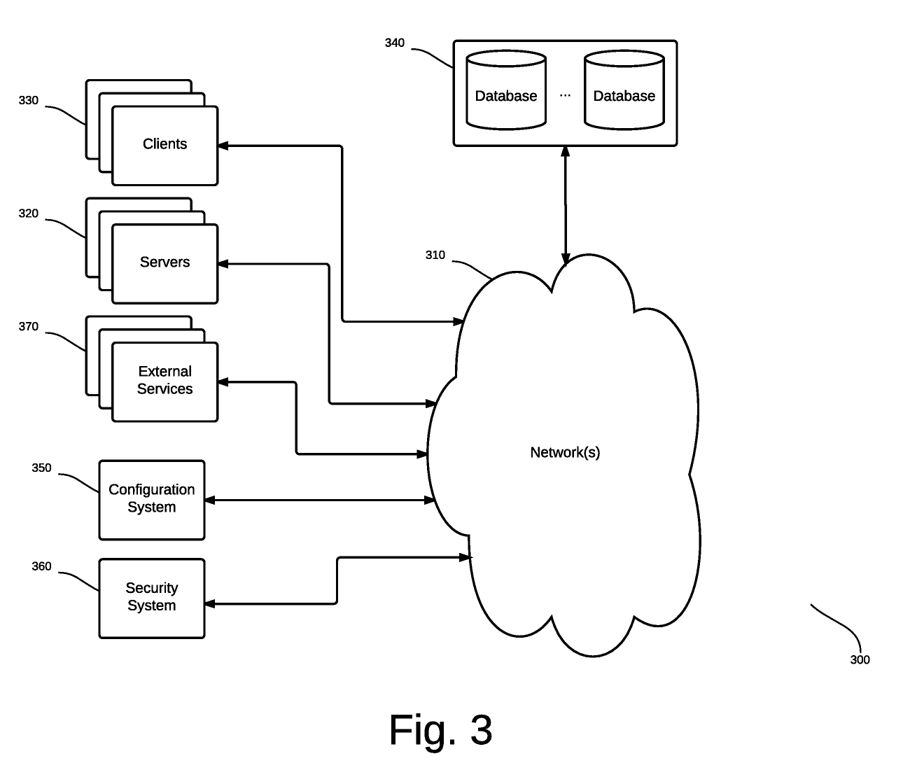

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run programmable instructions for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

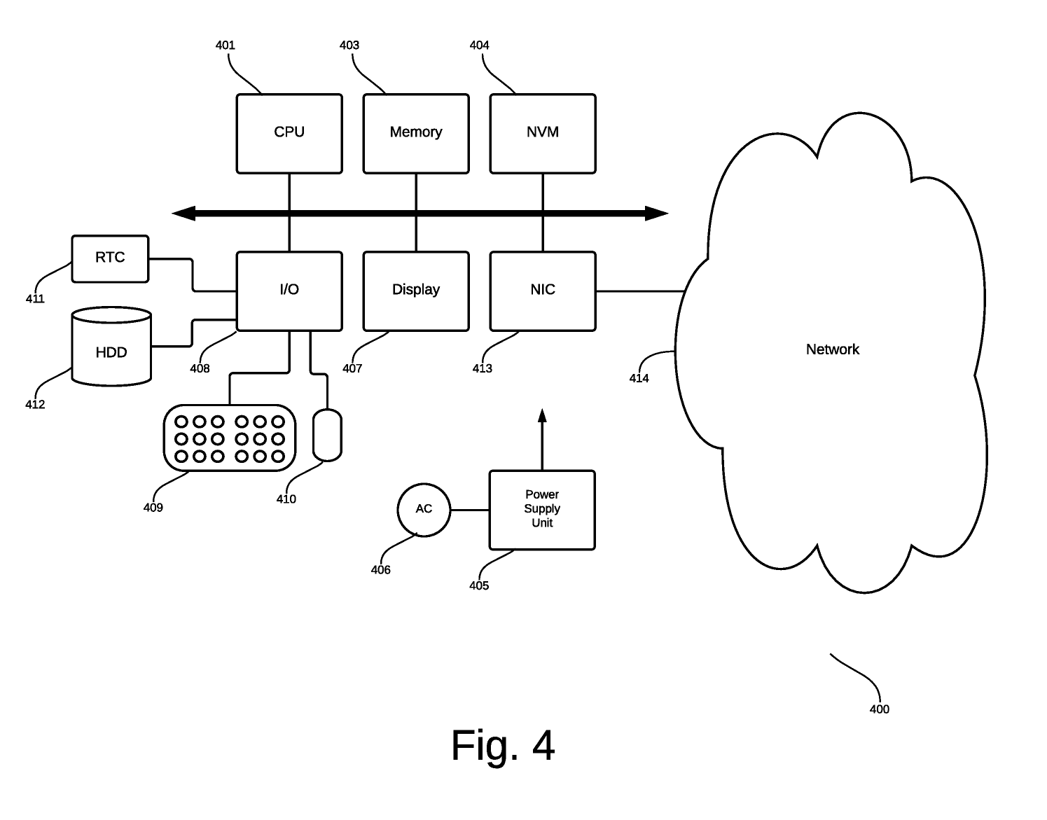

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

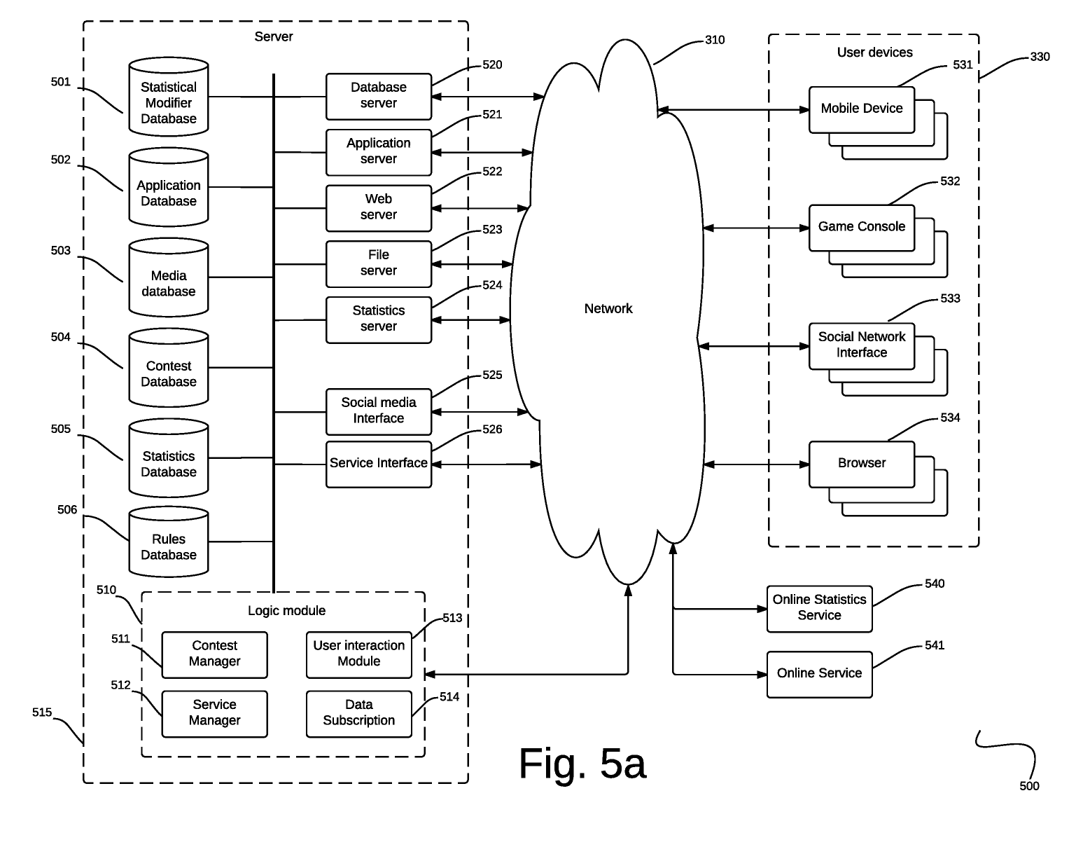

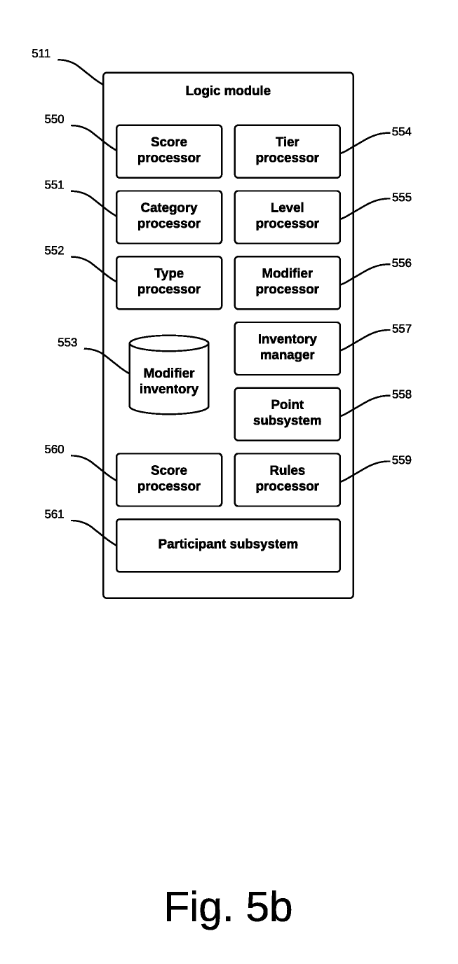

FIG. 5a is an exemplary architecture of a de-randomization system in an augmented reality gaming environment using statistical modifiers, according to a preferred embodiment of the invention. According to the embodiment, databases 501 to 506 may comprise file data comprising configuration for user devices 330 and storage corresponding to user device 330 such as sound data, user device 330 video data, system 515 sound data, system 515 video data, news sound data, news video data, and the like, stored in media database 503. Image data may comprise user device 330 image data, system 515 image data, news image data, team image data, athlete image data, and the like stored in media database 503. It should be appreciated that media data may be sent to one or more user devices 330 to enrich a user experience. User device 330 data may comprise user news data, leaderboard updates, user device 330 activity, posts, follow and the like, stored in media database 503. System 515 data may comprise usage data, contest data, social network relationship data, and stored in application database 502. Social relationships may be obtained through a plurality of users within the system, by interfacing to other social networks, via social media interface 525, for example, Facebook™, Twitter™, LinkedIn™, SnapChat™, and the like. Statistic data may comprise data from live events, virtual events and specific characteristics of the events, for example, sport schedules, sport match information such as start times, duration, and end times; results of the events, for example, scores, scorers, assists, player statistics, scoring summary, team statistics, individual athlete statistics, athlete season statistics, team season statistics, athlete news, team news, and the like, corresponding to a real event or a virtual event, and stored in statistics database 505.

Database service 520 processes requests relating to storing and retrieving data from various data sources and data storages 501-506. For example, saving an image to media database 503 and storing the web address of the image for retrieval of that resource. Database service 520 may provide a unified mechanism for storing information and adding new services or databases without affecting the existing structure of system 515. Application service 521 may process and manage background processes critical to system 515 (for example, calculate and store the results of contests, manages user device 330 requests, connects user devices 330 for contests, enables communication functionality between a plurality of user devices 330, and the like). Web service 522 may handle incoming and outgoing requests from network 310. In some embodiments web service 522 may provide reusable elements (such as an API) for other systems to interface to at least a portion of functionality available from server 515, for example, for an external gaming system to interface to statistical modifier management component logic module 510 (as described later in this document). File service 523 manages storage and retrieval of files used by system 515. For example, compression and file format conversion, access to internal or external data systems and file systems. Statistics service 524 manages event related statistics and news, for example, for sporting events, ESPN™, STATS™, STEAM™, and the like retrieved from online statistics service 540 or from another data provider via online service 541. In some embodiment, events may be other statistics, for example, stock price changes received from other service 541 throughout a session or a portion of a session, for example, NASDAQ™, NYSE™, FTSE™, and the like. In other embodiments, statistics may be a custom statistics source from online statistics service 540 corresponding to a particular game or to another real-life event such as a political election, for example, super-Tuesday results from a US primary election. Social media interface 525 manages creation, storage, and retrieval of social connection between user devices 330, contest participant devices 330 and other constituent devices 330 of system 515. Social media interface 525 may manage relationships and activities of user devices 330, for example, creating and saving a first user device 330 follow of another user device 330, interactions with external social networks or services such as Twitter™, Facebook™, Steam™, Play Station Network™, and the like. Service interface 526 may handle connections for system 515 to interface to online statistics server 540 and other online service 541, or for inter-device communication between a plurality of user devices 330. It should be appreciated that communications may be textual, multi-media, voice, VoIP, and the like, in an asynchronous or synchronous mode.

Logic module 510 performs logical processing of system 515 to configure, manage and execute contests and may comprise: contest manager 511 to manage contests and data manipulation of contests using statistical modifiers; service manager 512 to manage data from service interface 526; user interaction module 513 to send information to one or more user devices 330 and to manage interactions from one or more user devices 330; data subscription 514 may manage follows from a first user device 330 to a second user device 330 as well as manage information from online statistics 540 and online service 541 for one or more subscribed user devices 330 (for example, if a first user device 330 subscribes to statistics corresponding to a specific real event, data subscription 514 will filter events and information particular to the subscription for first user device 330).

User devices 330 comprise device described earlier and comprise: mobile device 531 such as a mobile smartphone, tablet, laptop, wearable device, and the like; game console 532 may be a computing gaming console such as a PlayStation™, XBOX™, Nintendo™, a portable game console such as a DS3™, and the like; social network interface 533 may be programmable instructions enabling a social network (for example Facebook™) to interface to system 515 through graphical, textual, or other means; browser 534 may be programmable instructions enabling a browser (for example, Chrome™, Edge™, Opera™, etc.) to interface to system 515 through graphical, textual, or other means.

In a preferred embodiment, server 515 may receive a plurality of selections form a user device 330, for example, in a fantasy gaming embodiment, basic information such a user device details, favorite teams (for example, as made available online service 541), favorite prizes, associations to one or more other user devices 330 (such as devices belonging to friends), a selection for user device 330 follow or unfollow (subscribe/unsubscribe) other user devices 330, or third party “feed” (via online another online service 541 that is capable to handle notifications, a request to search, in a fantasy gaming embodiment, athletes and teams (player/team search component), in this regard, user device 330 may subscribe/unsubscribe to notifications about one or more athlete or one or more teams, or both.

In a preferred embodiment, an administration user (for example, via mobile device 531) may configure retrieval of initial sport data from statistics service providers 540 (for example, STATS™) via statistics service 524. The raw data may be analyzed, converted and then stored in application database 502. Associated statistics data may then be stores in statistics database 505 by statistics server 524. At predetermined intervals, logic module 510, via data subscription 514, may receive the most recent game schedule data from statistics database 505. At predetermined intervals, logic module 510 may check the status of the events based on schedules received from online statistics server 540. If configured events correspond to a live event, statistics server 524 may get data from online statistics service 540 and convert data into a particular format and save the statistical data to internal statistic database 505. In some embodiments, at predetermined intervals, a state of all contests may be checked by logic module 510. If within a pre-configured threshold before a contest start time, if the contest is not full, logic module may match user devices 330 with other open contests, or mark contests that do not have matches as invalid. If a contest is full and the event is live, application server 521 may get the most recent statistics from the internal statistic database 505. Application server 521 may then calculate a fantasy score and apply statistical modifier (if applicable), display up-to-date fantasy score to one or more user devices 330. If a last event of a contest has completed, then contest post processing may begin by contest manager 511. In some embodiments, at least a portion of a fantasy score may be received by an external online service 541.

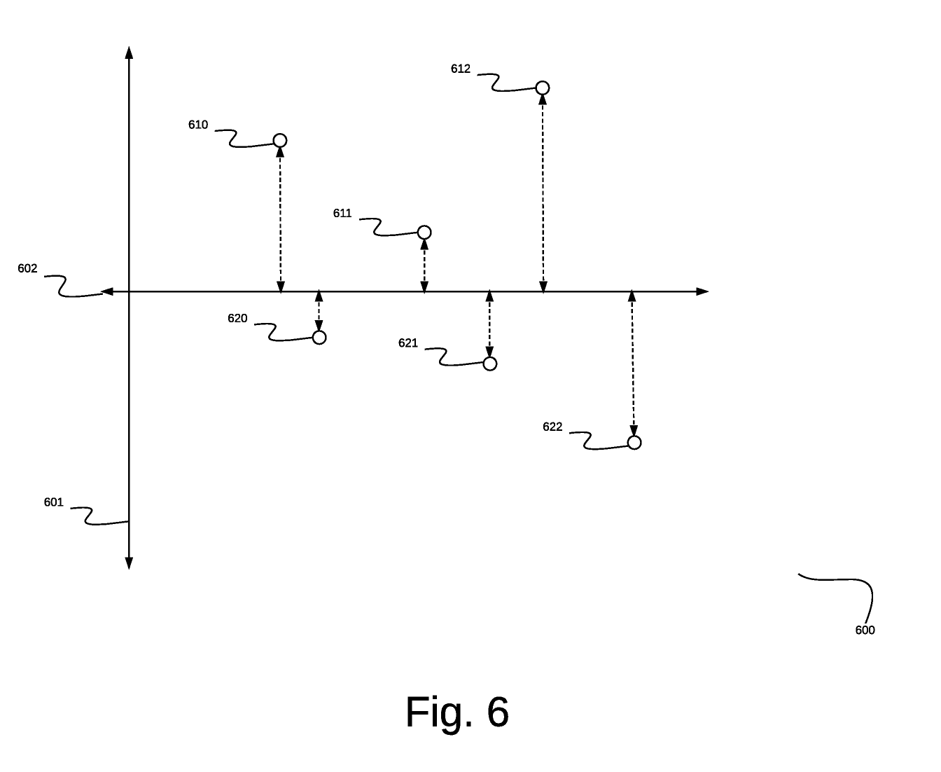

A typical contest life cycle may comprise one or more of the following: creation of a new contest by application server 521, wait for another user device 330 to join an existing contest, system may assign an opponent user device 330, a user device 330 may join an existing contest, application server 521 may determine contest validity. If application server 521 determines that a maximum number of contestants may have been reached before a first event start-time (associated to the contest), then the contest may be considered valid by application server 521. If not, the contest may be considered invalid and marked as inactive by application server 521. In this regard, the contest may be archived and no longer processed. Once application server 521 has deemed a contest as valid, all participant user devices 330 may be assigned 0-n statistical modifiers, each stored in statistical modifier database 501 and associated to a corresponding user device 330 (for example, a first user device 330 may be assigned three statistical modifiers). In some embodiments, statistical modifiers may be assigned randomly to one or more user devices 330, while in other embodiments, statistical modifiers may follow a specific algorithm for example, to promote more even play amongst contestant (as described in FIG. 6). In yet another embodiment, statistical modifiers may be purchased from an online “store”, in an offline “store” (for example, a code purchased at an online or from a physical store), or may be traded between user devices 330 or on a market. The code may then be used later by a user device 330 to assign an associated statistical modifier to statistical modifier database 501 and associated to the corresponding user device 330. A contest may reveal information at predetermined intervals by contest manager 511 (as configured in contest database 504 and based on rules database 506) to indicate status of other user devices 330, new elements in an inventory, or other information that may stimulate discourse, and/or gameplay between user devices 330. In some embodiments, when a contest event begins, modification by user devices 330 may become locked or immutable. In some embodiments, once the last event of a contest officially ends (for example, in a contest that comprises a plurality of events), contest post-processing, by contest manager 511, may take place. It should be appreciated that, in some embodiments, server 515 may create an augmented-reality contest corresponding to on one or more live events (that is a single contest spanning multiple real events to virtually form a single event) such as sporting events, stock market sessions, political rallies and the like. It can be appreciated that a single event in system 515 can represent a single combination of game elements in an augmented-reality fashion that would not be available in systems known in the art.

In some embodiments, creation of a new contest may comprise: a first user device 330 selects contest format, rules, contest type (for example, head-to-head, three versus three user devices, etc.). First user device 330 may select a category (for example, sporting events, stock charts, political rallies, etc.). Server 515 may show available event groupings to one or more user devices 330. First user 330 may select a plurality of event constraints—for example, one contest, beginning at a selected time, corresponding to six matches involving twelve teams, comprising fifteen athletes per team, ending when the last match has been completed whereby at least a portion of elements such as matches, teams, and athletes, may, in some embodiments, correspond to live events, though in other embodiments, at least a portion of elements may correspond to virtual system-generated elements. First user 330 may configure a number of contests (for example one, three, five, etc.). First user 330 may indicate an associated timing of contest for example, start-time, end-time, duration, etc. First user 330 may configure number of matches, amount to wager. First user 330 may select athletes and other contest characteristics. Received data from first user 330 may then be stored in contest database 504 and made available to one or more other user devices 330.

In a preferred embodiment, a contest reveal component may be configured throughout a contest by first user device 330 (or in other embodiments, by contest manager 511, for example, at predetermined intervals 0-n before a start-time of a contest. In this regard, contest information may be revealed to participant user devices 330 comprising one or more “reveal components” by contest manager 511. Once information has been shared, the revealed information may be locked (immutable) by contest manager 511. Based upon revealed information a user device 330 (of the participant user devices 330) may change contest characteristics, for example, increase a wager. Participant user devices 330 may be sent notifications, by application server 521, on teams and players corresponding to the contest as previously configured. In some embodiments, if before a contest (or event) whereby contest manager 511 has not locked the contest, one or more user devices 330 may change contest elements (for example, configured athletes). In some embodiments, if before a contest (or event) whereby contest manager 511 has not locked the contest, one or more user devices 330 may change one or more statistical modifiers (corresponding to the user device) by using, for example, credits. In some embodiments, one or more random new statistical modifiers may be assigned to one or more user devices 330 based on one or more preconfigured rules in rules database 506 by contest manager 511. In some embodiments, statistical modifier selection screen may present one or more unknown or mystery choice (i.e. a mystery statistical modifier). In some embodiments, a first user device 330 may use statistical modifiers already owned in a statistical modifier inventory system (described later) configured in statistical modifier database 501 corresponding to the first user device 330.

In some embodiments, once a contest has completed, a contest post-processing may commence by contest manager 511. In this regard, application server 521 may get raw data, for example, player, team, and other statistics from online statistics server 540 or form another online service 541. In some embodiments, based on contest rules pre-configured in rules database 506, contest post processing by contest manager 511 may calculate, for example, player score by using retrieved statistics from statistics service 540 (or from another online service 541) and applying one or more statistical modifiers, if applicable. In some embodiments, contest post processing by contest manager 511 may calculate total score by retrieving statistics from statistics service 540 (or from another online service 541) and applying one or more statistical modifiers, if applicable. In some embodiments, contest post processing by contest manager 511 may rank total scores for the contest and assign a final rank for each contestant of the contest. In some embodiments, contest post processing system may check contest parameters, for example, configuration of number of contests and determine next steps in processing outcomes. In some embodiments, contest post processing by contest manager 511 may award the amount wagered by a user device 330 based on contestant rank. In some embodiments, contest post processing by contest manager 511 may award random statistical modifiers (either by random user device 330 selection or direct assignment to a user device 330) using statistical modifier inventory system stored in statistical modifier database 501. In some embodiments, contest post processing by contest manager 511 may calculate new user device 330 rank based on credits and historical win/loss records in contest database 504 associated to user device 330.

In a preferred embodiment, statistical modifier 515 enables participant devices 330 to modify accuracy in relation to the predictions of the outcome of events, based on a contest, as an augmentation to what actually transpires in one or more real events, associated to the contest, by applying one or more statistical modifiers (that is, outcomes of a plurality of events in which the event was based on). For example, in a contest comprising predictions on a plurality of company stock prices, if a prediction for a particular user device 330 is that Apple™ stock price will rise, there may be various statistical modifiers that could be applied to compute a modification of the real outcome of that prediction, like a computation mechanism to increase revenue (based on the real revenue communicated), lower accounts payable, lower payroll, increase earnings per share, and the like. Said differently, any of the reported elements in a, for example, earnings report, may be modified, in an augmented-reality fashion, by statistical modifiers stored in statistical modifier database 501 by user device 330 to create virtual statistics to enable a de-randomization in an augmented reality gaming environment, the de-randomization creating a gaming environment whereby contest outcomes become more controllable by user device 330. In this regard, since statistical modifiers each have a specific function affecting at least a portion of the contest, strategy ensues and a more level playing field of gaming results—that is, for example, first user devices 330 that may be associated to users with a high skill level is able to play in a contest with users on a more “level playing” field such as a second user devices 330 associated to user with a lower skill level, by the second user device 330 controlling random elements by applying statistical modifiers to de-randomize (or mitigate) results of the associated events of the contest that would normally not typically be controllable by first and second user devices 330 (for example, stock results, game scores, team injuries, or any other aspect of contest parameters based on the type of contest). It should be appreciated by one with the skill in the art that statistical modifiers will correspond to specific elements of a category of gaming, though some statistical modifiers may apply more generally to the contest in total.

FIG. 5b is an exemplary architecture of a detailed contest manager in a de-randomization system in an augmented reality gaming environment using statistical modifiers, according to a preferred embodiment of the invention. According to the embodiment, statistical modifier creation is performed by logic module 510 and may comprise various inputs that may be required (for example, a category of contest and an associated type, for example, a sport) as received from an administration device 330. Statistical modifier creation by logic module 510 may generate one or more statistical modifiers from using the following processes: scope processor 550 may use inputs or pre-configurations, or both, to generate a scope of a statistical modifier (player statistic, athlete, total score, etc.); that is, one or more elements to which the statistical modifier applies; tier processor 554 may use inputs or pre-configurations, or both, to generate a range of effectiveness (for example, bronze, silver, gold) for the statistical modifier; category processor 551 may use inputs or pre-configurations, or both, to generate an appropriate category to which an associated statistical modifier may be applied (for example, touchdowns, blue chip stocks, etc.) based on a category for the contest or event; level processor 555 may use inputs (for example, input from tier processor 554 output) or pre-configurations, or both, to generate a statistical modifier level (for example, level 30); type processor 552 may use inputs (for example, level processor 555 output) or pre-configurations, or both, to generate the type of statistical modifier (for example, percentage or fixed value); modifier processor 556 may use inputs (for example, level processor 555 output) or pre-configurations, or both, to generate a modifier value (for example, +30 passing yards, −1 interceptions, +20 stock value, etc.). It should be appreciated that inputs or pre-configurations, or both, may be based on one or more rules from rules database 506 and be processed by rules processor 559.

In some embodiments, inventory manager 557 manages a virtual inventory of statistical modifiers collected by users (for example, saving statistical modifiers won in a contest, removing/applying statistical modifiers to a specific contest, accept offline statistical modifiers, accept traded statistical modifiers, etc.) and stores them in statistical modifier inventory 553.

In a preferred embodiment, points subsystem 558 (for example, points, experience, stars, sportbucks, etc.) may provide functionality as, for example, an underlying common commodity within the system. In some embodiments, points subsystem 558 may be consumed a number of various ways including, but not limited to, leveling up, purchasing lives, and wagering on contests. Points subsystem 558 may also, for example, have another related points system related that can be exchanged at higher or lower values (for example, 1 “A” point may be equal to 2 “B” points). In some embodiments, there may be no limit on the amount of points systems that may be interrelated to another.

In a preferred embodiment, contest view (or home view) may be delivered (or enabled) by system 515 as a default view for a contest. Contest view may allow a user device to start and participate in a contest. In a preferred embodiment, contest flow may comprise: a plurality of user devices 330 may begin by selecting from one of a plurality of available contests to play within a particular time period (for example, one day, week, etc.). As the time period progresses, contests may be removed from play, so a user device 330 electing to participate in the morning may have more options than a user device 330 electing to participate in the evening. In some embodiments, contest comprising events may be sorted by time and by sport (for example, MLB, NBA and NFL). In some embodiments, user devices 330 may draft a team based on rules of an associated game and available players. In some embodiments, user devices 330 may then attach a statistical modifier from their statistical modifier collection, stored in statistical modifier database 501, as allowed by the state of the contest by contest manage 511. In some embodiments, up to a pre-defined number of statistical modifiers (for example, three) can be assigned to a player within a contest, each statistical modifier slot unlocking, for example, at 3 hours, 2 hours and 1 hour before the game (within the associated contest) begins. At each unlock, a previous statistical modifier may be locked for the associated player or for the associated participant user device 330. In some embodiments, statistical modifiers may modify, for example, the player's stats (for example, add additional or percentage rushing yards for a running back). Once a game (in an associated contest) is complete, a score may be computed and a winner may be declared and delivered in a victory screen format to one or more user devices 330. In this regard, both the winner and loser may be awarded soft currency, point and/or statistical modifiers based on contest results.

In a preferred embodiment, statistical modifiers may represent virtual statistical modifiers for player, team and/or event statistics. In this regard. statistical modifiers may have different tiers of rarity and statistics. In some embodiments, statistical modifiers may modify more than one stat and may have a positive or negative effect, for example, a statistical modifier may grant additional points for a touchdown pass, but may remove 50 passing yards. In some embodiments, user devices 330 may have a limited number of statistical modifiers they can hold in modifier inventory 553. In some embodiments, user devices 330 may purchase, sell, trade additional inventory slots with a premium currency

In a preferred embodiment, a leaderboard view may be presented by server 515 to user devices 330 that comprises a leaderboard for user devices 330 based on points for a particular period of time (for example, a day). In some embodiments, real-time scores for all event (for example, NBA, NFL and MBL games) may be delivered to one or more user devices 330. In some embodiments, a news feed containing relevant player and sport based news (such as a player being put in the disabled list) may be delivered to one or more user devices 330.

In a preferred embodiment, each player of a contest may have a publicly viewable profile visible by user devices 330. User devices 330 may see their wins and best overall score in a game. In some embodiments, access may be given so that a first user device 330 is able to view another user device 330's profile—accordingly, a user device 330 may follow another user device 330 to see updates on a user feed associated to the another user device 330. In some embodiments, system 515 may facilitate communication between a plurality of user devices 330 (for example, a “shout”) via service interface 526, which may be a public mention in the user feed (for example, a Twitter™ mention via social media interface 525).

### Detailed Description of Exemplary Embodiments

FIG. 6 is an exemplary embodiment of a statistical modifier deviation algorithm, according to a preferred embodiment of the invention. According the embodiment, when one or more participant user devices 330 are added to a contest, they are algorithmically placed on a graph based on historical performance, stored in contest database 506, based on contest type and contest category. Historical performance for a first user device 330 may be based on a number of previous contest wins, deviation from other participant user devices 330 performance in previous competitions, overall wins, streak wins (for example, a number of consecutive wins with no, or few, losses), number of points, number of records, amount of winnings based on wagers, or other criteria. According to the embodiment, line 602 may be an x-axis representing an average (or median) performance for all participant devices 330 for the contest. That is, the x-axis is calculated once all the participant user devices 330 are finalized for the contest. In this regard, participants 610, 611, and 612 (each corresponding to a participant user device 330), for example, represent participant user devices that have a higher than average performance based on historical results. A larger distance form line 602 would represent a higher skill than others. Accordingly, participants 620, 621, and 622 (each corresponding to a participant user device 330) would represent lower skilled devices based on historical performance with participant 622 being the skilled in this arrangement. In some embodiments, skill level may be calculated via user input or configuration rather than historical performance, or a combination of configuration and historical performance.

Once a relative position is calculated for each participant 610-612, and 620-622, a modifier factor is assigned to each participant 610-612, and 620-622. The modifier factor determines a subset of statistical modifiers that may be assigned to the associated participant. The subset is based on increasing (or decreasing) points through statistical modification to “level the playing field”. That is, players with a high skill may not receive statistical modifiers that affect the outcome, whereas players with low skill may receive statistical modifiers that allow for a bigger impact on final score. In this regard an augmented-reality gaming environment where users of different skills may play together such that a clear winner can seldom be predicted.

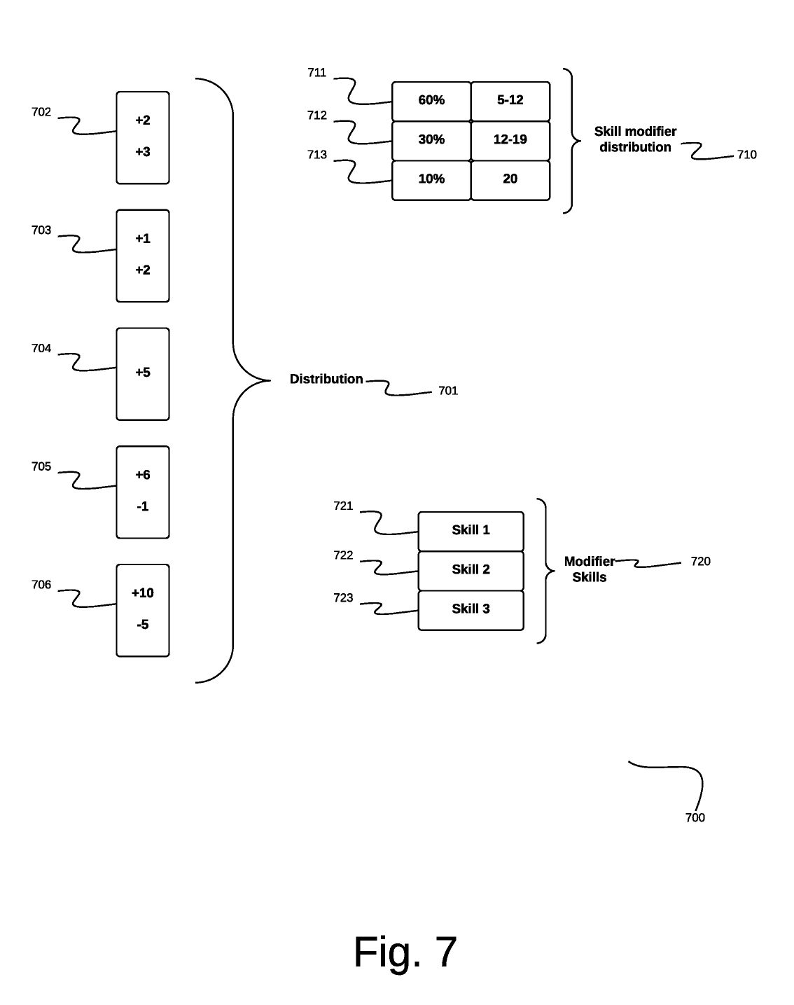

FIG. 7 is an exemplary embodiment of a statistical modifier skill distribution, according to a preferred embodiment of the invention. According to the embodiment, distribution 701 illustrates various embodiments in which statistical modifiers can be assigned. For example, a +5 modifier 704 may be delivered to affect one or two statistics of contest. for example, a +5 modifier may be a single +5 that can be applied to a particular statistic or to an entire contest—for example, +5 points on a basketball game, +5 assist point on a fantasy hockey game, or, it may be split into two separate sub-modifiers 705 representing +6 and −1, for example, a +6 for an assist and a −1 for a score. In this regard, a savvy player may assign sub-modifiers 705 to a player (that is, a contest element) that is known to assist more than score. It can be appreciated that this type of augmentation to reality-events creates a new dimension to gaming such that skills go from knowing a sport and being at the mercy of the outcome of a game to a strategic game based on statistical modifiers whereby users of any skill (that is, any skill in the target sport or event that a contest may be based on) can play at a level commensurate with other players.

referring again to distribution 701, sub-modifiers 702, 703, and 706 may be additional sub-divisions of modifiers to add complexity and strategy for de-randomization in an augmented reality gaming environment. It can be appreciated that by providing statistical modifiers, a plurality of users across many skill levels may participate in a

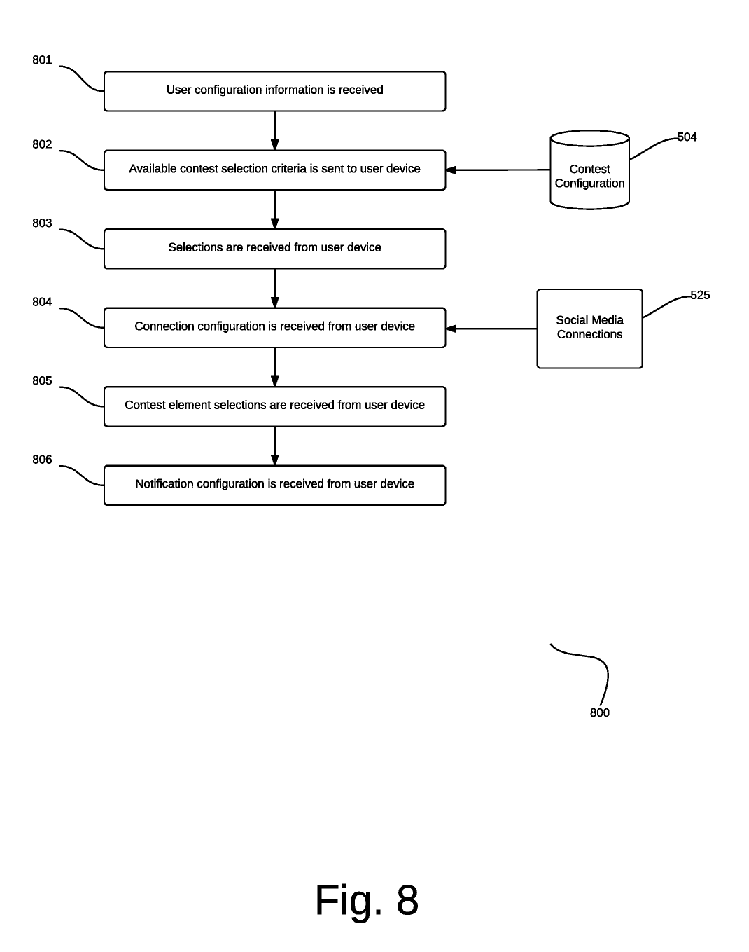

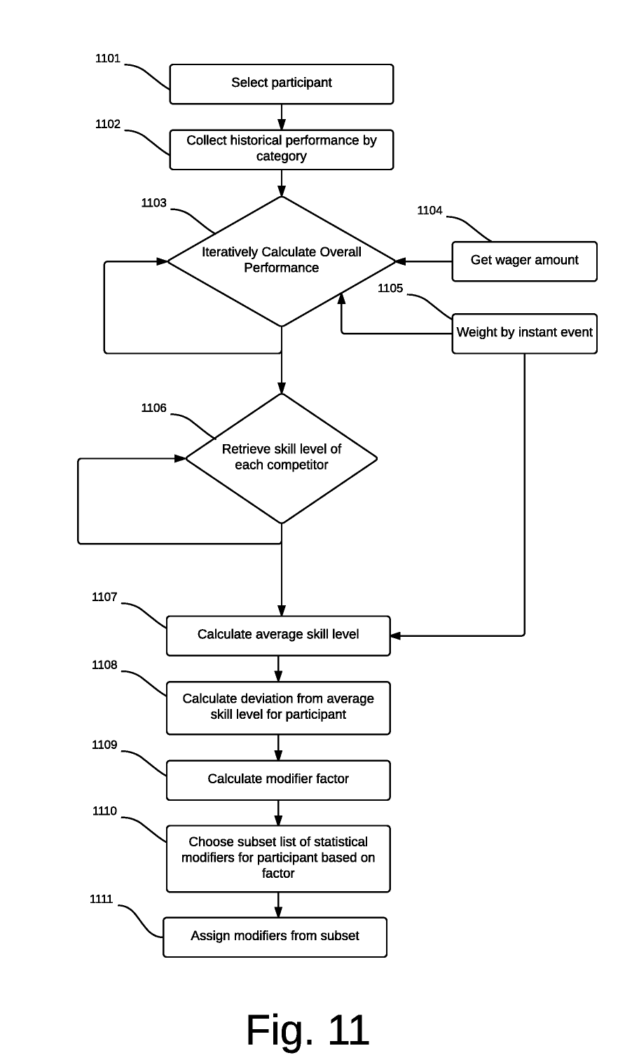

FIG. 8 is an exemplary process flow for configuring a contest, according to a preferred embodiment of the invention. In a first step 801, user device configuration is received form a plurality of user devices 330. Configuration may be dependent on a type of user device (for example, mobile device, game console, social network module, browser extension). User device configuration may comprise information about preferences such as preferred contest types (for example, sports, financial markets, politics, etc.). In some embodiments, if a first user device 330 was not previously registered with application database 502, a new user device 330 profile is created and an identifier associated with first user device 330. In other embodiments, is first user device 330 already exists in database 502, historical performance information may be realized or associated to first user device 330. Using historical performance, a modifier factor may be calculated (as in FIG. 11) to pre-determine types of statistical modifiers that may be sent to first user device 330.

In a next step 802, all available contests available to first user device 330, from contest configuration database 504, are sent to user device 330 via network 310. First user device 330 may display available contests via an associated display based on the user device type.

In a next step 803, contest manager may receive one or more contest selections from first user device 330.

In a next step 804, social media connector 525 may access social networks associated to first user device 330 and receive connection information of profiles associated to first user device 330. In some embodiments, user device 330 is presented with an ability to select opponents for a contest using this connection information. In some embodiments, connections already registered with application database 502 may be highlights, and those not registered may be identified with an ability to invite to the contest. In this regard, connections may be presents with a social media interface 533 to participate in the contest.

In a next step 805, selections of contest elements may be received by contest manager 511 and associated to the user device 330 from which it received the selection

In a next step 806, notification configuration is received from user devices 330 to indicate which notifications they wish to receive before, during, and after the contest. Notification may be, for example, real-time information on scoring (for example scores, baskets, homeruns, stock prices, election results, etc.).

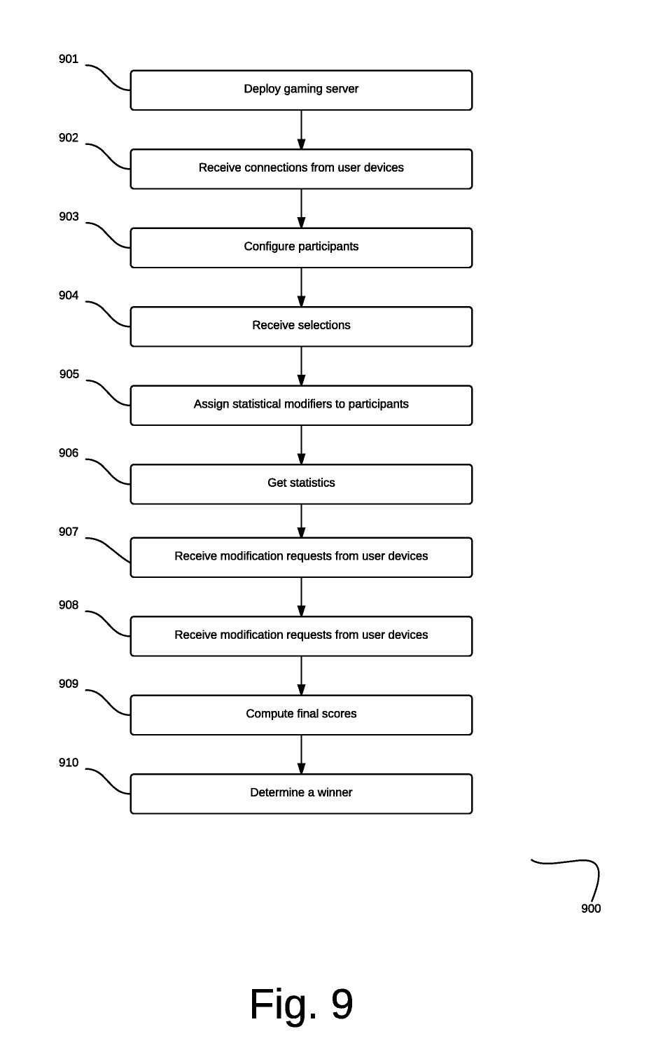

FIG. 9 is an exemplary high-level process flow for executing a contest, according to a preferred embodiment of the invention. According to the embodiment, in a first step 901, gaming server 506 is deployed wherein gaming server 506 is connected to network 310 and comprises memory 101 and processor 103 and further comprises programmable instructions stored in memory 101 and operating on processor 103, the instructions configured to modifying one or more results received from statistics service 524 (for example, player roster results and statistics from a sporting event, prices from a trading session corresponding to ticker symbols of publicly held companies that are issued and traded either through exchanges or over-the-counter markets, and other statistics) for a fantasy multi-player network gaming contest. In some embodiments, gaming server 506 may comprise a plurality of processors 103 and a plurality of memories 101 connected locally or remotely over network 310 (for example, the internet, a LAN, WAN, cellular network, etc. or a combination thereof). In some embodiments, all components may be on one specially programmed computing device.

In a next step 902, a plurality of connections from a plurality of client devices 330 are received at application server 521 via network 310. User devices 330 may be one or more specially programmed mobile devices 531, gaming console 532 (for example, XBOX™, Sony PlayStation™, Nintendo Wii™, or the like), social network interface 533 (for example, Facebook™, Twitter™, LinkedIn™, etc.), or browser 534 (for example, Google Chrome™, Microsoft Edge™, Opera™, etc.).

In a next step 903 participants are configured by contest manager 511 wherein a plurality of identifiers are received from first user device 330, the identifiers corresponding to a plurality of other user devices 330 to participate in a fantasy contest (that is, invitations to join a fantasy contest). An identifier corresponding to first user device 330 combined with a plurality of identifiers corresponding to the plurality of other user devices 330 (hereinafter, collectively referred to as “participant devices”) and associated to a contest identifier and stored in contest database 504.

In a next step 904, receiving, at contest manager 511, a plurality of entity selections from the plurality of user devices 330 participating in the fantasy contest, the entity selections corresponding to a plurality of elements (for example, teams, players, stocks, etc. to which statistics associated to the elements will define the scoring of the contest) the plurality of elements associated to an identifier associated to a corresponding user device. In a next step 905, contest manager 511 sends a plurality of statistical modifiers in the contest to a first participant user device 330 associated to the contest. Statistical modifiers assigned to the first participant device 330 may be based on a random selection, a computation based on sill deviation (referring to FIG. 6), or by some other computational means. Contest manager 511 may continue to send a plurality of additional statistical modifiers in the fantasy contest to additional participant user device 330 associated to the contest.

In a next step 906, statistics service 524 may receive a plurality of statistics associated to the selected elements of the contest from online statistics server 540 and/or online service 541 comprising a plurality of results based on results from an associated event. In some embodiment, events may be real events such as a sporting event or stock trading data. In other embodiments, events may be virtual events based on virtual systems.

In a next step 907, contest manager 511 may send the plurality of results to the plurality of participant user devices 330 based on the plurality of entity selections corresponding to each participant user device 330. In some embodiments, at this step one or more participant user devices may modify selections, add statistical modifiers, or other actions (for example, increase an associated wager).

In a next step 908, contest manager may receive a first request, from a first participant user device 330, to apply one or more statistical modifiers of the first plurality of statistical modifiers to one or more results to modify the one or more results. Contest manager 511 may continue to receive additional requests to apply one or more statistical modifiers (or other modifications) to modify the one or more results associated to a participant user device.

In a next step 909, contest manager 511 may compute a plurality of modified results for each participant user device 330 based on received statistics combined with statistical modifiers to compute a final score for each participant user device 330.

In a next step 910, scores for each participant user device 330 are compared and a winner participant device of the contest is identified.

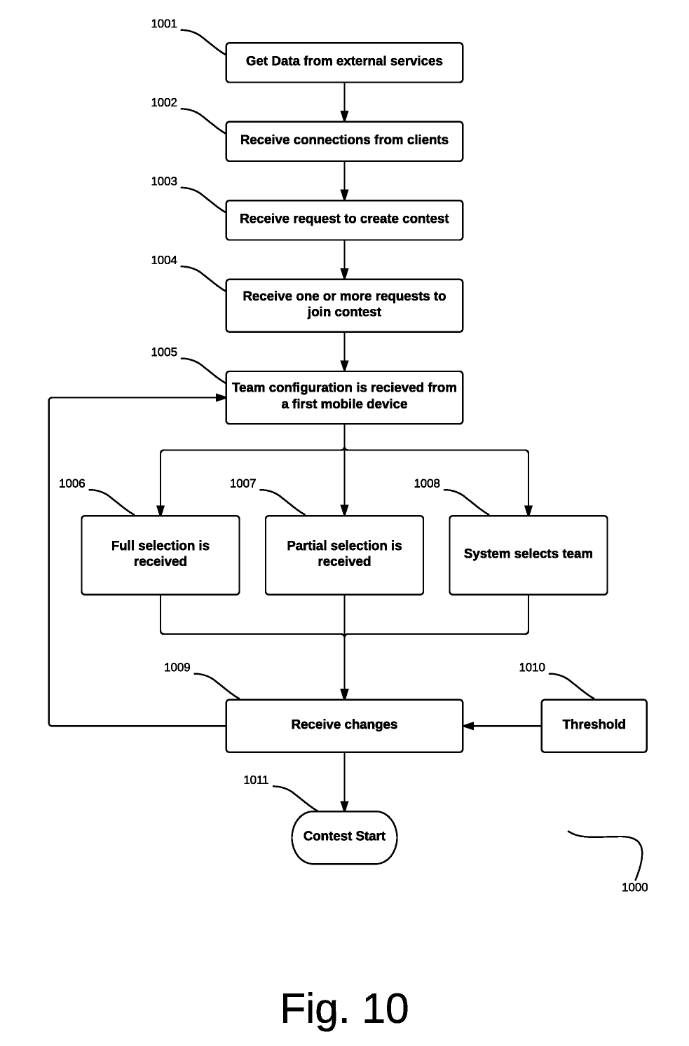

FIG. 10 is an exemplary process flow for selecting contest member identifiers in a contest, according to a preferred embodiment of the invention. According to the embodiment, in a first step 1001, a plurality of data is received from get data from online statistics server 540 comprising a plurality of game elements (for example, in a fantasy sports environment, player names, team names, sport types, etc.), or from online service 541 (for example, financial market data comprising stock ticker symbols, stock prices, and other associated financial market and trade-related data). Game elements comprise elements for contest scoring by score processor 560. One or more participant user devices 330 will select elements to comprise contest data for the associated participant user device 330.

In a next step 1002, a plurality of connections may be received from a plurality of user devices and register with application database 502. Registered user devices 330 are capable of seeing and being added to contests.

In a next step 1003, contest manager 511 may receive a request, from a first user device 330, to create a contest whereby parameters of the contest are defined by first user device 330. Parameters may define the type of contest such as sport, how many matches, duration, thresholds for betting or making changes, available contest elements for score calculation, and the like.

In a next step 1004, contest manager 511 may receive one or more requests to join the contest from other user devices 330. In some embodiments, participant subsystem 561 may be an automated participant in the contest having similar capabilities of user devices 330 to act as an automated participant whereby contest elements may be selected randomly or based on one or more rules from rules database 506. User devices 330 electing to participate (and participant subsystem 561) are hereinafter referred to as, participant devices.

In a next step 1005, contest configuration, comprising contest elements, is received from each participant device. In a fantasy sports embodiment, contest configuration may be a selection of players, teams, etc. In a political rally, contest configuration may comprise identifiers corresponding to names of senators, congressmen, or presidential candidates.

In a next step 1006, a full selection is of contest elements may be received and contest configuration for the associated participant device is stored in contest database 504. Alternative to step 1006, in step 1007, a partial selection of contest elements is received and contest manager 511 may complete the selection randomly or based on one or more rules from rules database 506. Contest configuration for the associated participant device is then stored in contest database 504. Alternative to step 1006 and 1007, in step 1008, contest manager may select contest elements for an associated participant device. Contest configuration for the associated participant device is then stored in contest database 504.

In a next step 1009, any changes to contest elements may be received, by contest manager 511, to modify contest elements or to apply statistical modifiers. In some embodiments, a threshold is defined in step 1010 to limit when changes can be made. In a next step 1011, the contest starts.

FIG. 11 is an exemplary process flow for calculating a modifier factor for a user device for de-randomization in an augmented reality gaming environment, according to a preferred embodiment of the invention. In a first step 1101, a participant 611 is selected from a plurality of contest participants 610-612, and 620-622, each participant associated to a user device 330.

In a next step 1102, a historical performance records by category is retrieved from contest database 506, the records corresponding to participant 610. Historical performance for a participant 610 may be based on a number of previous contest wins, deviation from other participants' performance from previous competitions (which may or may not include participants 610-612, and 620-622). Performance may include, overall wins, streak wins (for example, a number of consecutive wins with no, or few, losses), number of points, number of records, amount of winnings based on wagers, or other criteria.

In a next step 1103, an iterative process to calculate overall performance for participant 610 is performed based on specific criteria of the instant contest (for example, based on match numbers, contest type, other participants, historical interaction with other participants, etc.). In some embodiments, a calculation of all participants is performed in step 1103. In an optional step 1104, a wager amount may be received from participant 610.

In a next step 1106, a skill level for each competitor participant is retrieved from contest database 506. In some embodiments, a calculation of competitor participants is performed in step 1106.

In a next step 1107, Calculate average skill level 602 is calculated for all participants 610-612, and 620-622. In some embodiments, a median rather than an average is calculated for participants 610-612, and 620-622.

In a next step 1105, a weight may be based on characteristics of the instant event. For example, in a UFC competition where a believed clear winner is participating, a weighting may be added to at least a portion of the contest or contest elements.

In a next step 1108, a deviation is calculated for participant 610 from average skill level 602 for all participants 610-612, and 620-622. In a next step 1109, a modifier factor is calculated for participant 610. It should be appreciated that a modifier factor may provide an indication of a grouping of statistical modifiers that can be delivered by contest manager 511 to participant 610. That is, a subset group of statistical modifiers is created based on the contest and where the various participants fall with respect to the average skill. It should be appreciated that a subset of statistical modifiers may correspond to statistical modifiers commensurate with the participant's skill level—that is, for low skilled participants, a subset of statistical modifier with more effectiveness would correspond.

In other embodiments a modifier factor may represent a percent by which a statistical modifier is modified, for example, a high-skill participant 610 may have a −10% modifier factor whereby at least a portion of statistical modifiers that are delivered to participant 610, are reduced (in effectiveness) by 10%, whereas, for example, a lower skilled participant 622 may be assigned a +25% modifier factor whereby at least a portion of statistical modifiers that are delivered to participant 622, are increased (in effectiveness) by 25%.

In a next step 1110, in the case where a subset of modifiers is used, contest manager 511 will assign a commensurate subset list of statistical modifiers for participant based on factor that corresponds to skill level.

In a next step 1111, one or more modifiers from the subset, from step 1110, are assigned to participant 610.

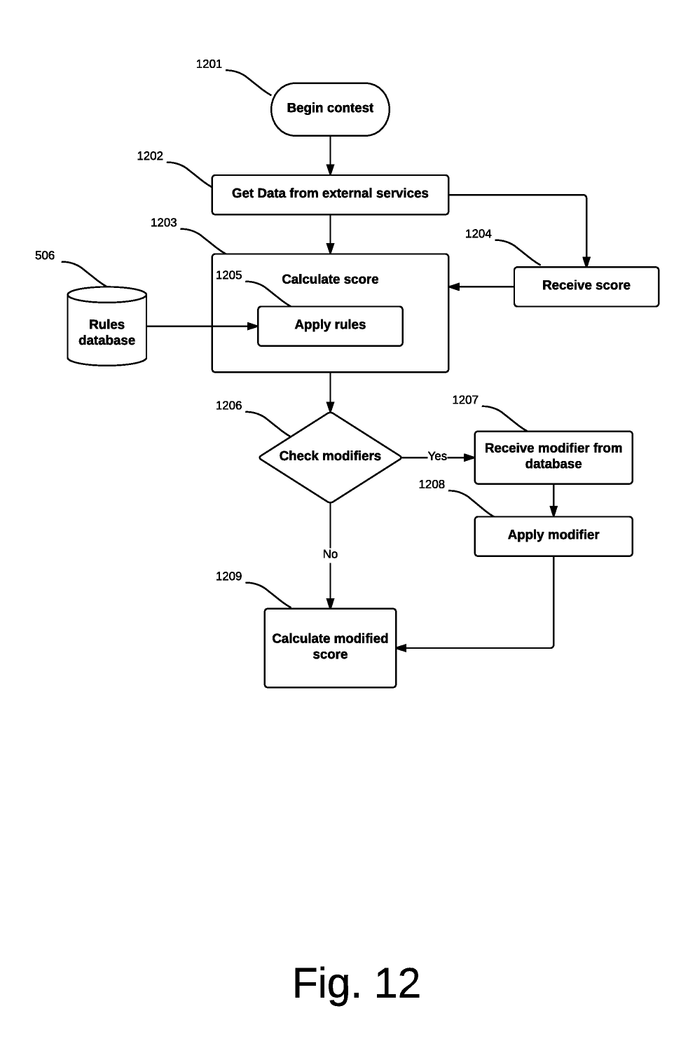

FIG. 12 is an exemplary process flow for applying a statistical modifier factor for a user device for de-randomization in an augmented reality gaming environment, according to a preferred embodiment of the invention. According to the embodiment, in a first step 1201, a contest (as described previously) pertaining to a fantasy sports contest commences once a plurality of participants comprised of one or more user devices 330 (and optionally participant subsystem 561) has been configured. In this example, each participant may have forms virtual teams based on players corresponding to one or more real sporting events. The virtual team configured by each participant form the gaming elements for which the competition will be based upon.

In a next step 1202, statistical data is retrieved from online statistic service 540 and/or online service 541. Statistical data may correspond to scores, assists, and other interactions from the real sporting event. It should be appreciated that in some embodiments, where there is a different type of contest (such as a fantasy stock market or fantasy political rally contest) data retrieved from statistic service 540 and/or online service 541 may be transactional data, voting data, and the like, may be retrieved instead of statistic information.

In a next step 1203, a plurality of scores are calculated, by score processor 550, based on data received in step 1202 and based on the elements configured in step 1201. That is, a fantasy score for each element may be calculated based on what happened in an associated real event, and one or more rules, from rules database 506, are applied, by score processor 550, in step 1205 to create a score for each element for each participant. During a contest, scores are received periodically, in step 1204, and scores are updated, by score processor 550, accordingly by, in 1203, as additional score information is received. Once the contest has ended, a final score is calculated, by score processor 550, using any applicable rule from rules database 506.

In a next step 1206, statistical modifiers associated to each participant are reviewed. In some embodiments, all statistical modifiers associated to a participant are checked, in other embodiments, only assigned statistical modifiers are checked. In a next step 1207, statistical modifiers that have been previously applied to the contest for a participant are used to modify the score from step 1203. In some embodiments, individual scores for individual elements are modified by statistical modifiers, in other embodiments, particular statistical modifiers may only modify the score of one or more elements. In some embodiments, a statistical modifier may modify the total score from step 1203. In a next step 1208, all applicable statistical modifiers are applied to the score or scores associated to the participant.

In a next step 1209, a modified score is calculated for the participant based on statistics, elements and statistical modifiers.

This process may be repeated for all participants and a winner is declared for the contest.

The skilled person will be aware of a range of possible modifications of the various embodiments described above. Accordingly, the present invention is defined by the claims and their equivalents.

What is claimed is:

1. A method for modifying results for fantasy multi-player network-gaming comprising:
deploying a network-connected gaming server comprising at least a memory and a processor and further comprising programmable instructions stored in the memory and operating on the processor, the instructions configured to modifying one or more results for fantasy multi-player network gaming comprising the steps of:
receiving, at a client interface, a plurality of connections via the network from a plurality of user devices;
receiving, at a contest manager, a plurality of identifiers corresponding to user devices participating in a fantasy contest;
receiving, at the contest manager, a plurality of entity selections from the plurality of user devices participating in the fantasy contest, the entity selections corresponding to a plurality of elements, the plurality of elements associated to an identifier associated to a corresponding user device;
the contest manager sending a first plurality of statistical modifiers in the fantasy contest to a first participant user device associated to the contest;
the contest manager sending a second plurality of statistical modifiers in the fantasy contest to a second participant user device associated to the contest;
receiving, at a contest scoring module, a plurality of results from a network-connected external service;
the contest scoring module sending the plurality of results to the plurality of participant user devices based on the plurality of entity selections corresponding to each user device;
receiving, at the contest scoring module, a first request to apply one or more statistical modifiers of the first plurality of statistical modifiers to one or more results to modify the one or more results, from the first participant user device;
receiving, at the contest scoring module, a second request to apply one or more statistical modifiers of the second plurality of statistical modifiers to one or more results to modify the one or more results, from the second participant user device;
computing, at the contest scoring module, a plurality of modified results for the first user device to compute a first final score;
computing, at the contest scoring module, a plurality of modified results for the second user device to compute a second final score;
comparing the first final score to the second final score to determine a winner of the contest.

2. The method of claim 1, wherein the plurality of entities are a plurality of players in one or more actual sporting events.

3. The method of claim 2, wherein the plurality of results are a plurality of statistical performance values of the plurality of players.

4. The method of claim 1, wherein the plurality of entities are a plurality of ticker symbols of publicly held companies that are issued and traded either through exchanges or over-the-counter markets.

5. The method of claim 4, wherein the plurality of results are a plurality of values that correspond to a plurality of actual prices, each price corresponding to a ticker symbol of the plurality of ticker symbols.

6. The method of claim 1, further comprising the step of periodically revealing, at a contest timer module, one or more contest parameters to one or more user devices corresponding to one or more unique identifiers of the contest.

7. The method of claim 6, wherein a first contest parameter of the one or more contest parameters is selected from the group consisting of a first statistical modifier of the first plurality of statistical modifiers, a first selected entity corresponding to the first user identifier.

8. A method for assigning one or more statistical modifiers for multi-player network-gaming comprising:
deploying a network-connected gaming server comprising at least a memory and a processor and further comprising programmable instructions stored in the memory and operating on the processor, the instructions configured to assigning one or more statistical modifiers for multi-player network gaming comprising the steps of:
receiving, at a client interface, a plurality of connections from a plurality of user devices;
assigning, at a device manager, a unique identifier to each user device of the plurality of user devices;
receiving, from a first user device having a first unique identifier, a request to create a contest;
adding the first unique identifier to the contest;
receiving, from the first user device, a second unique identifier corresponding to a second user device;
sending, to the second user device, an invitation to join the contest;
receiving, at the client interface, a response to the invitation from the second user device;
responsive to receiving a positive response, adding, at the game server, the second unique identifier to the contest;
presenting, to the first user device and the second user device, a plurality of entities;
receiving, at the contest manager, a plurality of selected entities selected by the first user device;
receiving, at the contest manager, a plurality of selected entities selected by the second user device;
assigning, at a statistical modifier manager, one or more statistical modifiers to a first statistical modifier inventory, the first statistical modifier manager inventory associated to the first unique identifier;
assigning, at a statistical modifier manager, one or more statistical modifiers to a second statistical modifier inventory, the second statistical modifier inventory associated to the second unique identifier.

9. The method of claim 8, wherein the plurality of entities are a plurality of players in one or more actual sporting events.

10. The method of claim 8, wherein the plurality of entities are a plurality of ticker symbols of publicly held companies that are issued and traded either through exchanges or over-the-counter markets.

11. A system for modifying results for fantasy multi-player network-gaming comprising:
a network-connected gaming server comprising at least a memory and a processor and further comprising programmable instructions stored in the memory and operating on the processor, the instructions configured to modifying one or more registers comprising results for fantasy multi-player network gaming comprising:
a communications server configured to receive a plurality of connections via the network from a plurality of user devices and assign a unique identifier to each user device;
a statistics interface to receive results from one or more network-connected external services;
a contest manager configured to:
configure one or more contests;
assign a start-time to each of the one or more contests;
access contest information associated with one or more user devices;
assign a plurality of identifiers corresponding to user devices participating to a contest;
assign a plurality of events to the one or more contests;
receive a plurality of entity selections corresponding to plurality of entities of the plurality of events from the plurality of user devices participating in the contest;
associate one or more statistical modifiers to one or more unique identifiers;
a contest timer module to:
compute a contest window;
determine a plurality of reveal times for revealing one or more contest parameters to one of more user devices;
a contest scoring module to:
receive a plurality of requests from the plurality of user devices to apply one or more statistical modifier to one or more results.
apply one or more statistical modifiers to one or more results corresponding to one or more selected entities selected by a first user device to compute a first final score;
apply one or more statistical modifiers to one or more results corresponding to one or more selected entities selected by a second user device to compute a second final score;
compare the first final score to the second final score to determine a winner of the contest;
a statistical modifier manager to associate a plurality of statistical modifiers to the plurality of user devices.

12. The system of claim 11, wherein the contest timer module assigns a contest time window beginning with a first contest start-time of a first contest and ending with a start-time of a first event of a first plurality of events configured for the first contest;

13. The system of claim 11, wherein the contest timer module assigns a contest time window beginning from a contest creation time of a first contest to an end-time of a last event of a first plurality of events configured for the first contest;

14. The system of claim 11, wherein the plurality of entities are a plurality of players in one or more actual sporting events.

15. The system of claim 11, wherein the plurality of entities are a plurality of ticker symbols of publicly held companies that are issued and traded either through exchanges or over-the-counter markets.
